(19) United States
(12) Patent Application Publication
(10) Pub. No.: US 2020/0142582 A1
(43) Pub. Date: May 7, 2020

(54) DISAMBIGUATING GESTURE INPUT TYPES USING MULTIPLE HEATMAPS

(71) Applicant: Google LLC, Mountain View, CA (US)

(72) Inventors: Philip Quinn, San Jose, CA (US); Shumin Zhai, Los Altos, CA (US); Wenxin Feng, Sunnyvale, CA (US)

(21) Appl. No.: 16/619,069

(22) PCT Filed: Sep. 17, 2018
(86) PCT No.: PCT/US2018/051368

§ 371 Date: Dec. 3, 2019

Related U.S. Application Data
(60) Provisional application No. 62/597,767, filed on Dec. 12, 2017.

(51) Int. Cl. G06F 3/0488

(52) U.S. Cl. CPC G06F 3/04883

(57) ABSTRACT

A computing device is described that receives indications representative of a user input entered at a region of a presence-sensitive screen over a duration of time. The computing device may determine, based on the indications representative of the user input, a plurality of multi-dimensional heatmaps indicative of the user input. Based on the plurality of multi-dimensional heatmaps, the computing device may determine changes, over the duration of time, in a shape of the plurality of multi-dimensional heatmaps, and determine, responsive to the changes in the shape of the plurality of multi-dimensional heatmaps, a classification of the user input. The computing device may then perform an operation associated with the classification of the user input.

### BACKGROUND

Some computing devices (e.g., mobile phones, tablet computers) may receive user input that is entered at a presence-sensitive screen. For instance, a presence-sensitive screen of a computing device may output a graphical user interface (e.g., an interface of a game or an operating system) that permits the user to enter commands by tapping and/or gesturing over other graphical elements (e.g., buttons, scroll bars, icons, etc.) displayed at the presence-sensitive screen. The commands may be associated with different operations that the computing device may perform, such as invoking an application associated with the graphical element, relocating a graphical element within the graphical user interface, switching between different aspects (e.g., pages) of the graphical user interface, scrolling within aspects of the graphical user interface, etc.

In order to distinguish between different types of gesture inputs, the computing device may determine relevant locations indicating, for example, where the gesture was initiated within the presence-sensitive display, an ending location indicating where the gesture was terminated within the presence-sensitive display, and possibly one or more intermediate locations indicating locations of the gesture that occurred between the starting location and the ending location. The computing device may also determine one or more time durations of the gesture (e.g., a duration associated with each of the relevant locations). Based on time durations of the gesture and the relevant locations, the computing device may determine a classification of the type of gesture, such as whether the gesture was a tap, a long-press (as measured, for example, by the determined time duration exceeding a long-press duration threshold), a long-press slide, a long-press swipe, etc.

Such duration-based gesture classification may be slow (as a result of having to wait for various duration thresholds to pass). Furthermore, duration-based gesture classification may be imprecise given that the gesture is reduced to a series of one or more locations and one or more durations. The slow, imprecise nature of duration-based gesture classification may result in the computing device determining a classification for a command that is inconsistent with the command intended to be entered by the user via the gesture. Resulting in, potentially, an unresponsive and unintuitive user experience.

### SUMMARY

In one example, the disclosure is directed to method comprising receiving, by one or more processors of a computing device, indications representative of a user input entered at a region of a presence-sensitive screen over a duration of time, and determining, by the one or more processors and based on the indications representative of the user input, a plurality of multi-dimensional heatmaps indicative of the user input. The method also comprises determining, by the one or more processors and based on the plurality of multi-dimensional heatmaps, changes, over the duration of time, in a shape of the plurality of multi-dimensional heatmaps, and determining, by the one or more processors and responsive to the changes in the shape of the plurality of multi-dimensional heatmaps, a classification of the user input. The method further comprises performing, by the one or more processors, an operation associated with the classification of the user input.

In another example, the disclosure is directed to a computing device comprising a presence-sensitive screen configured to output indications representative of a user input entered at a region of a presence-sensitive screen over a duration of time, and one or more processors configured to determine, based on the indications representative of the user input, a plurality of multi-dimensional heatmaps indicative of the user input. The one or more processors are also configured to determine, based on the plurality of multi-dimensional heatmaps, changes, over the duration of time, in a shape of the plurality of multi-dimensional heatmaps, and determine, responsive to the changes in the shape of the plurality of multi-dimensional heatmaps, a classification of the user input. The one or more processors are also configured to perform an operation associated with the classification of the user input.

In another example, the disclosure is directed to a computer-readable medium having stored thereon instructions that, when executed, cause one or more processors to receive indications representative of a user input entered at a region of a presence-sensitive screen over a duration of time, determine, based on the indications representative of the user input, a plurality of multi-dimensional heatmaps indicative of the user input, determine, based on the plurality of multi-dimensional heatmaps, changes, over the duration of time, in a shape of the plurality of multi-dimensional heatmaps, determine, responsive to the changes in the shape of the plurality of multi-dimensional heatmaps, a classification of the user input, and perform an operation associated with the classification of the user input.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to disambiguate user input in accordance with one or more aspects of the present disclosure.

FIG. 2 is a block diagram illustrating another example computing device that is configured to disambiguate user input in accordance with one or more aspects of the present disclosure.

FIG. 3 is a block diagram illustrating an example computing device that outputs graphical content for display at a remote device in accordance with one or more techniques of the present disclosure.

FIGS. 4A-4C are conceptual diagrams illustrating example sequences of heatmaps used by the computing device to perform disambiguation of user input in accordance with various aspects of the techniques described in this disclosure.

FIG. 5 is a conceptual diagram illustrating an example heatmap used by the computing device to determine a classification of user input in accordance with various aspects of the techniques described in this disclosure.

FIG. 6 is a flowchart illustrating example operations of a computing device that is configured to perform disambiguation of user input in accordance with one or more aspects of the present disclosure.

### DETAILED DESCRIPTION

In general, this disclosure is directed to techniques for enabling a computing device to disambiguate user input based on a plurality of multi-dimensional heatmaps associated with the user input received over a duration of time via a presence-sensitive screen. The computing device may perform what may be referred to as a shape-based disambiguation through analysis of how the multi-dimensional heatmaps change shape over the duration of time. Rather than rely on disambiguation schemes that only consider a duration of time with which the user interacted with the computing device, the shape-based disambiguation techniques set forth in this disclosure may consider the actual shape of a heatmap associated with the user input and/or how the shape of the heatmap associated with the user input changes over the duration of time.

The computing device may identify when a user is pressing the presence-sensitive screen based on how the shape changes over the duration of time. That is, using multi-dimensional heatmaps indicative of a capacitance detected via a two-dimensional region of a present-sensitive display, the computing device may identify, using the shape-based disambiguation, when the user is pressing firmly on the present-sensitive display rather than tapping on the presence-sensitive display. To illustrate, as the capacitance values in the multi-dimensional heatmap increases, the computing device may determine that the user is pressing on the presence-sensitive display.

As such, the techniques of this disclosure may improve operation of the computing device. As one example, the techniques may configure the computing device in a manner that facilitates more rapid classification of user inputs compared to disambiguation schemes that rely solely on time thresholds. Furthermore, the techniques may, through the increased amount of information, facilitate more accurate classification of user inputs that results in less misclassification of the user input. Both benefits may improve user interaction with the computing device, thereby allowing the computing device to more efficiently (both in terms of processor cycles and power utilization) identify user inputs. The more rapid classification provided by the techniques may allow the computing device to utilize less processing cycles over time, thereby conserving power. The better accuracy provided by the techniques may allow the computing device to respond as the user expects such that the user need not undo the unintended operation launched through misclassification of the user input, and reenter the user input in an attempt to perform the intended operation, which may reduce the number of processing cycles and thereby conserve power.

Throughout the disclosure, examples are described wherein a computing device and/or computing system may analyze information (e.g., heatmaps) associated with the computing device the user of the computing device only if the computing device and/or the computing system receives explicit permission from the user of the computing device to analyze the information. For example, in situations discussed below in which the computing device and/or computing system may collect or may make use of communication information associated with the user and the computing device, the user may be provided with an opportunity to provide input to control whether programs or features of the computing device and/or computing system can collect and make use of user information (e.g., heatmaps), or to dictate whether and/or how the computing device and/or computing system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user. Thus, the user may have control over how information is collected about the user and used by the computing device and/or computing system.

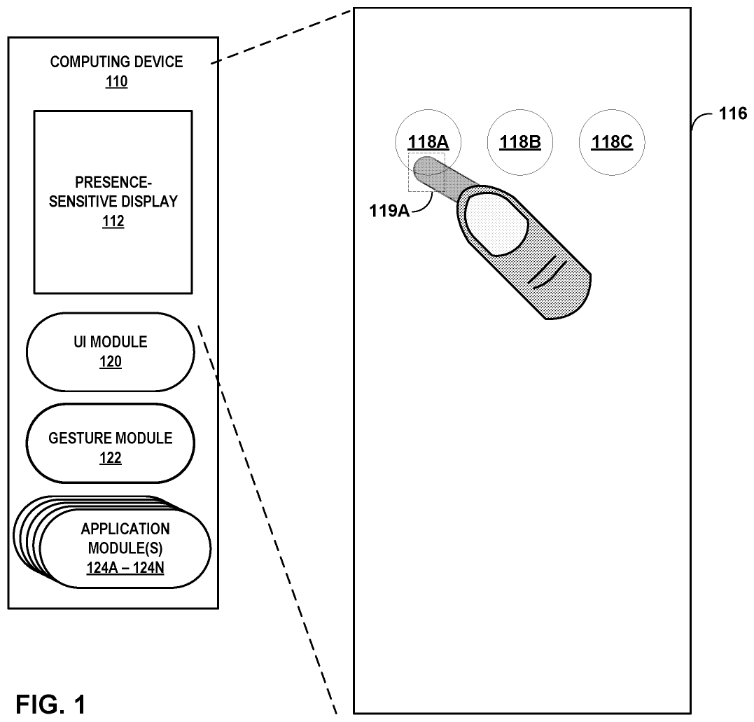

FIG. 1 is a conceptual diagram illustrating computing device 110 as an example computing device that is configured to disambiguate user input in accordance with one or more aspects of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle cockpit displays, or any other types of wearable and non-wearable, mobile or non-mobile computing devices that may output a graphical keyboard for display.

Computing device 110 includes a presence-sensitive display (PSD) 112 (which may represent one example of a presence-sensitive screen), user interface (UI) module 120, gesture module 122, and one or more application modules 124A-124N (“application modules 124”). Modules 120-124 may perform operations described using hardware, or a combination of hardware and software and/or firmware residing in and/or executing at computing device 110. Computing device 110 may execute modules 120-124 with multiple processors or multiple devices. Computing device 110 may execute modules 120-124 as virtual machines executing on underlying hardware. Modules 120-124 may execute as one or more services of an operating system or computing platform. Modules 120-124 may execute as one or more executable programs at an application layer of a computing platform.

PSD 112 of computing device 110 may represent one example of a presence-sensitive screen, and function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive screen technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may receive tactile input from a user of respective computing device 110. PSD 112 may receive indications of tactile input by detecting one or more gestures from a user (e.g., the user touching or pointing to one or more locations of PSD 112 with a finger or a stylus pen). PSD 112 may output information to a user as a user interface, which may be associated with functionality provided by computing device 110. For example, PSD 112 may present various user interfaces related to keyboards, application modules 124, the operating system, or other features of computing platforms, operating systems, applications, and/or services executing at or accessible from computing device 110 (e.g., electronic message applications, Internet browser applications, mobile or desktop operating systems, etc.).

UI module 120 manages user interactions with PSD 112 and other components of computing device 110. For example, UI module 120 may output a user interface and may cause PSD 112 to display the user interface as a user of computing device 110 views output and/or provides input at PSD 112. In the example of FIG. 1, UI module 120 may interface with PSD 112 to present user interface 116. User interfaces 116 includes graphical elements 118A-118C displayed at various regions of PSD 112. UI module 120 may receive one or more indications of input from a user as the user interacts with the user interfaces (e.g., PSD 112). UI module 120 may interpret inputs detected at PSD 112 and may relay information about the detected inputs to one or more associated platforms, operating systems, application modules 124, and/or services executing at computing device 110, for example, to cause computing device 110 to perform operations.

UI module 120 may, in other words, represent a unit configured to interface with PSD 112 to both present user interfaces, such as user interface 116, and receive indications representative of a user input at a region of PSD 112. PSD 112 may output the indications representative of the user input to UI module 120, including identifying the region of PSD 112 at which the user input was received. UI module 120 may receive and process the output from PSD 112 prior to gesture module 112 classifying the user input. UI module 120 may process the indications in any number of ways, such as processing the indications to reduce, as one example, the indications down to a sequence of one or more points that occur over a duration of time.

To process the user input, UI module 120 may receive the indications representative of the user input as a sequence of capacitance indications. The capacitance indications may represent the capacitance reflective of the user input at an initial region 119A. The capacitance indications may define capacitance for each point of a two-dimensional grid in region 119A of PSD 112 (thereby defining what may be referred to as a “heatmap” or a “capacitive heatmap”). UI module 120 may assess the capacitance indications for region 119A to determine a centroid reflective of the primary point of the user input at region 119A. That is, the user input may span multiple capacitive points in the two-dimensional grid, having different capacitive values reflective of the extent to which the user makes contact with PSD 112. The higher the capacitive value, the more extensive the contact with PSD 112, and the better the indication that the underlying capacitive point was the intended location of the user input. UI module 120 may determine the centroid coordinate using any number of processes, some of which may involve implementation of spatial models (such as computation of centroids for virtual keyboard user interfaces) involving bivariate Gaussian models for graphical elements (e.g., keys in the virtual keyboard user interfaces).

UI module 120 may output one or more centroid coordinates instead of the capacitance indications as the indications representative of the user input to facilitate real-time, or near-real-time processing of the user input. Real-time, or near-real time processing of the user input may improve the user experience by delaying latency and enabling better responsiveness. UI module 120 may output the centroid coordinates along with a timestamp, for each of the centroid coordinates, indicating when each of the indications from which the centroid coordinates were determined. UI module 120 may output the centroid coordinates and corresponding timestamps as indications representative of the user input to gesture module 122 and/or other modules not shown in the example of FIG. 1 for ease of illustration processes.

Although shown separate from PSD 112, UI module 112 may be integrated within PSD 112. In other words, PSD 112 may implement the functionality described with respect to UI module 120, either in hardware, or a combination of hardware and software.

Gesture module 122 may represent a component configured to process the one or more indications representative of the user input to determine a classification of the user input. Gesture module 122 may determine different types of classifications, including a long-press even, a tap event, a scrolling event, a drag event (which may refer to a long-press followed by a movement), and the like.

Gesture module 122 may perform time-based thresholding in order to determine, based on the indications representative of user input, the classification of the user input. For example, gesture module 122 may determine the long-press event classification when the centroid coordinates remain in a relatively stable position for a duration (measured by the difference in the corresponding timestamps) that exceeds a long-press duration threshold. Gesture module 122 may, in the time-based thresholding, a tap event classification when the final timestamp in a temporal ordering of the timestamps is less than the tap duration threshold.

Gesture module 122 may also perform spatial thresholding in order to determine, based on the indications representative of user input, various spatial event classifications, such as a scrolling event classification, a swipe event classification, a drag event classification, etc. For example, gesture module 122 determine a scrolling event classification when the difference between two centroid coordinates exceeds a distance threshold.

Gesture module 122 may output the classification of the user input to the UI module 120. UI module 120 may perform an operation associated with the classification of the user input, such as scrolling user interface 116 when the classification indicates a scrolling event, open a menu when the classification indicates a long-press event, or invoke one of application modules 124 when the classification indicates a tap event.

UI module 120 may, in some instances, perform the operation relative to a graphical element, such as graphical elements 118. For example, UI module 120 may determine one or more underlying graphical elements 118 displayed at a location within PSD 112 identified by the one or more centroids (or, in other words, centroid coordinates). UI module 120 may then perform, relative to one or more of graphical elements 118, the operation associated with the classification of the user input. To illustrate, consider that the user input is classified as a long-press event centered on graphical element 118A and that graphical element 118A is an icon associated with one of application modules 124, UI module 120 may generate a long-press menu including operations capable of being performed by the one of application modules 124, and interface with PSD 112 to update user interface 116 to show the long-press menu having quick links to perform additional operations provided by the one of application modules 124.

Each of applications modules 124 is an executable application, or subcomponent thereof, that performs one or more specific functions or operations for computing device 110, such as an electronic messaging application, a text editor, an Internet webpage browser, or a game application. Each application module 124 may independently perform various functions for computing device 110 or may operate in collaboration with other application modules 124 to perform a function.

As noted above, gesture module 122 may perform time-based thresholding to determine a number of different classifications of the user input. Although time-based thresholding may allow for functional interactions with computing device 110 via PSD 112, often times the various duration thresholds introduce latency that may impact the user experience, and introduce arbitrary timeliness into user input detection. While shortening the duration thresholds may improve the overall user experience, the shortened duration threshold may result in incorrect disambiguation of user input, where for example user input intended to be a long-press is incorrectly classified as a scrolling event, or other incorrect classification of user input. Even infrequent misclassification can result in a user experience that is frustrating, as the user may consider use of computing device 110 unintuitive and the operation thereof incorrect and failed.

In accordance with the techniques described in this disclosure, gesture module 122 may perform heatmap-based disambiguation of the user input. Rather than reduce the heatmap to a single centroid coordinate mapped to one pixel of PSD 112, the gesture module 122 may receive a sequence of heatmaps (either in full or partially), which as noted above, UI module 120 may determine based on the indications representative of the user input. The sequence of heatmaps (which may also more generally be referred to as “a plurality of heatmaps” as the techniques may operate with respect to heatmaps received in non-sequential order) may provide a more detailed representation of the user input compared to a sequence of centroid coordinates, thereby potentially allowing for faster, more accurate disambiguation of the user input.

Given that the heatmaps provide a two-dimensional representation of the user input (e.g., a square of capacitance indications surrounding the centroid coordinate) and that the sequence of heatmaps vary over a third dimension (that is, time), the sequence of heatmaps may be referred to as a sequence of multi-dimensional heatmaps. Based the sequence of multi-dimensional heatmaps representative of the user input over a duration of time, gesture module 122 may determine changes, over the duration of time, in a shape of the sequence of multi-dimensional heatmaps.

The changes in shape may denote may different types of events. For example, as the user presses their finger against the screen the natural plasticity of the finger may result in shapes that expand in shape, potentially denoting more pressure being applied to PSD 112 that gesture module 122 may disambiguate as a hard press event. As another example, gesture module 122 may disambiguate little changes in shape as a tap event or a light press event. In this respect, gesture module 122 may determine, responsive to the changes in the shape of the multi-dimensional heatmaps, a classification of the user input.

Gesture module 122 may, in some examples, combine time-based and shape-based disambiguation, using the shape-based disambiguation to potentially more quickly determine a classification of the user input or facilitate accuracy of the classification process. For example, gesture module 122 may more quickly determine that the user input is a press event using the changes in shape (e.g., as quickly as 100 milliseconds (ms)) thereby allowing the time-based threshold to be set lower (which is commonly as much as 500 ms in a sole time-based disambiguation scheme). As another example, gesture module 122 may determine that a user input is a tap event based on both the changes in shape and relative to a tap event threshold, using the additional information in the form of the change in shapes to facilitate verification of the tap event and reduce instances where an intended tap user input is misunderstood as a scroll event.

Gesture module 122 may also utilize the shape of any one of the sequence of heatmap to derive additional information about the user input. For example, gesture module 122 may determine, based on the shape of one or more of the sequence of multi-dimensional heatmaps which hand of the user was used to enter the user input. As another example, gesture module 122 may also determine which finger of the user was used to enter the user input.

Gesture module 122 may output the classification to other modules of the operating system (which are not shown in the example of FIG. 1 for ease of illustration purposes), which may perform some operation associated with the classification of the user input (e.g., invoke one of application modules 124, pass the classification to one of application modules 124—which may itself perform the operation, such as scrolling, transition, present menus, etc.). Generally, computing device 110 may, in this respect, perform an operation associated with the classification of the user input.

As such, the techniques of this disclosure may improve operation of computing device 110. As one example, the techniques may configure computing device 110 in a manner that facilitates more rapid classification of user inputs compared to disambiguation schemes that rely solely on time thresholds. Furthermore, the techniques may, through the increased amount of information, facilitate more accurate classification of user inputs that results in less misclassification of the user input. Both benefits may improve user interaction with computing device 110, thereby allowing the computing device 110 to more efficiently (both in terms of processor cycles and power utilization) identify user inputs. The more rapid classification provided by the techniques may allow computing device 110 to utilize less processing cycles over time, thereby conserving power. The better accuracy provided by the techniques may allow computing device 110 to respond as the user expects such that the user need not undo the unintended operation launched through misclassification of the user input, and reenter the user input in an attempt to perform the intended operation, which may reduce the number of processing cycles and thereby conserve power.

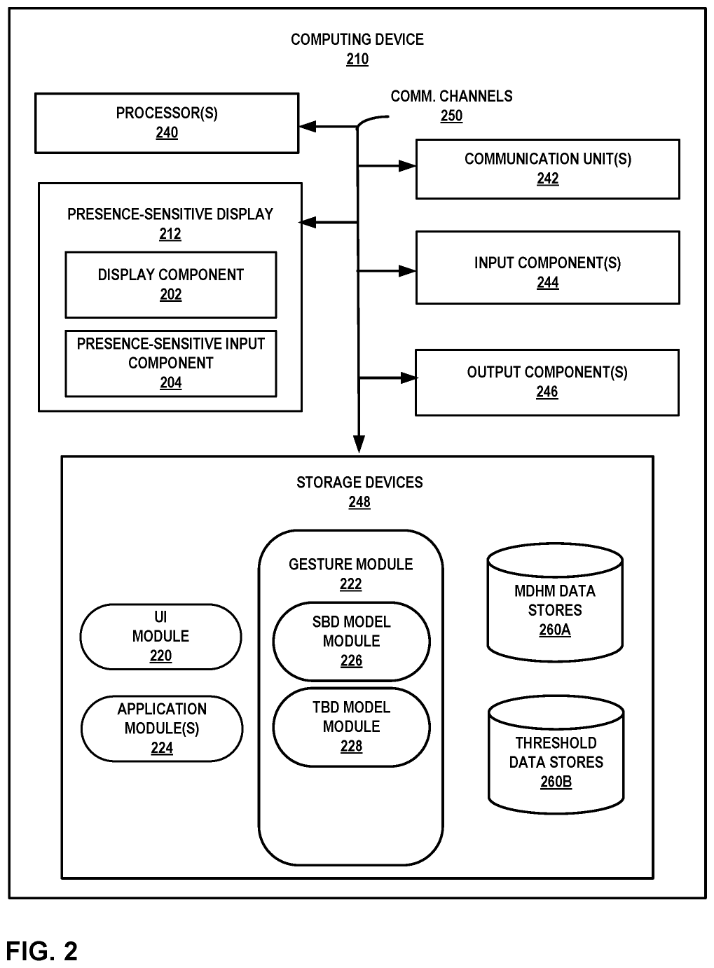

FIG. 2 is a block diagram illustrating an example computing device that is configured to present a graphical keyboard, in accordance with one or more aspects of the present disclosure. Computing device 210 of FIG. 2 is described below as an example of computing device 110 illustrated in FIG. 1. FIG. 2 illustrates only one particular example of computing device 110, and many other examples of computing device 210 may be used in other instances and may include a subset of the components included in example computing device 210 or may include additional components not shown in FIG. 2.

As shown in the example of FIG. 2, computing device 110 includes PSD 212, one or more processors 240, one or more communication units 242, one or more input components 244, one or more output components 246, and one or more storage components 248. Presence-sensitive display 212 includes display component 202 and presence-sensitive input component 204. Storage components 248 of computing device 210 may include UI module 220, gesture module 222, and one or more application modules 224. Additionally, storage components 248 are configured to store multi-dimensional heatmap (“MDHM”) stores 260A and threshold data stores 260B (collectively, “data stores 260”). Gesture module 222 may include shape-based disambiguation (“SBD”) model module 226 and time-based disambiguation (“TBD”) model module 228. Communication channels 250 may interconnect each of the components 212, 240, 242, 244, 246, 248, 220, 222, 224, 226, 228, and 260 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

PSD 212 of computing device 210 includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interface 116 for receiving text input and outputting a character sequence inferred from the text input as shown in FIG. 1).

While illustrated as an internal component of computing device 210, PSD 212 may also represent and an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may receive tactile input from a user of computing device 210. PSD 212 may receive indications of the tactile input by detecting one or more tap or non-tap gestures from a user of computing device 210 (e.g., the user touching or pointing to one or more locations of PSD 212 with a finger or a stylus pen). PSD 212 may present output to a user. PSD 212 may present the output as a graphical user interface (e.g., graphical user interfaces 114 of FIG. 1), which may be associated with functionality provided by various functionality of computing device 210. For example, PSD 212 may present various user interfaces of components of a computing platform, operating system, applications, or services executing at or accessible by computing device 210 (e.g., an electronic message application, a navigation application, an Internet browser application, a mobile operating system, etc.). A user may interact with a respective user interface to cause computing device 210 to perform operations relating to one or more the various functions. The user of computing device 210 may view output presented as feedback associated with the text input function and provide input to PSD 212 to compose text using the text input function.

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 224, 226, and 228 may be operable by processors 240 to perform various actions, operations, or functions of computing device 210. For example, processors 240 of computing device 210 may retrieve and execute instructions stored by storage components 248 that cause processors 240 to perform the operations modules 220, 222, 224, 226, and 228. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 226, and 228 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, 226, and 228, as well as data stores 260. Storage components 248 may include a memory configured to store data or other information associated with modules 220, 222, 224, 226, and 228, as well as data stores 260.

UI module 220 may include all functionality of UI module 120 of computing device 110 of FIG. 1 and may perform similar operations as UI module 120 for managing a user interface (e.g., user interface 116) that computing device 210 provides at presence-sensitive display 212 for handling input from a user. UI module 220 may transmit a display command and data over communication channels 250 to cause PSD 212 to present the user interface at PSD 212. For example, UI module 220 may detect an initial user input selecting one or more keys of a graphical keyboard. Responsive to detecting the initial selection of one or more keys, UI module 220 may generate one or more touch events based on the initial selection of the one or more keys.

Application modules 224 represent all the various individual applications and services executing at and accessible from computing device 210. A user of computing device 210 may interact with an interface (e.g., a graphical user interface) associated with one or more application modules 224 to cause computing device 210 to perform a function. Numerous examples of application modules 224 may exist and include, a fitness application, a calendar application, a personal assistant or prediction engine, a search application, a map or navigation application, a transportation service application (e.g., a bus or train tracking application), a social media application, a game application, an e-mail application, a messaging application, an Internet browser application, or any and all other applications that may execute at computing device 210.

Gesture module 222 may include all functionality of gesture module 122 of computing device 110 of FIG. 1 and may perform similar operations as gesture module 122 for disambiguating user input. That is, gesture module 222 may perform various aspects of the techniques described in this disclosure to disambiguate user input, determining a classification of the user input based on a sequence of heatmaps as described above.

SBD model module 226 of gesture module 222 may represent a model configured to disambiguate user input based on a shape of the sequence of multi-dimensional heatmaps stored to MDHM data stores 260A. In some examples, each of the heatmaps of the sequence of multi-dimensional heatmaps represents capacitance values for a region of presence sensitive display 212 for an 8 ms duration of time. SBD model module 226 may, as one example, include a neural network or other machine learning model trained to perform the disambiguation techniques described in this disclosure.

TBD model module 228 may represent a model configured to disambiguate user input based on time-based, or in other words, duration-based thresholds. TBD model module 228 may perform time-based thresholding to disambiguate user input. TBD model module 228 may represent, as one example, a neural network or other machine learning model trained to perform the time-based disambiguation aspects of the techniques described in this disclosure. Although shown as separate models, SBD model module 226 and TBD model module 228 may be implemented as a single model capable of performing both the shape-based and time-based disambiguation aspects of the techniques described in this disclosure.

Both SBD model module 226 and TBD model module 228, when applying neural networks or other machine learning algorithms, may be trained based on a sets of example indications representative of user input (such as the above noted heatmaps and centroids, respectively). That is, SBD model module 226 may be trained using different sequences of heatmaps representative of user input, each of the sequences of heatmaps associated with the different classification events (e.g., long press event, tap event, scrolling event, etc.). SBD model module 226 may be trained until configured to classify unknown events correctly with some confidence level (or percentage). Similarly, TBD model module 228 may be trained using different centroid sequences representative of user input, each of the centroid sequences associated with different classification events (e.g., long press event, tap event, scrolling event, etc.).

MDHM data stores 260A may store the plurality of multi-dimensional heatmaps. Although described as storing the sequence of multi-dimensional heatmaps, MDHM data stores 260 may store other data related to gesture disambiguation, including the handedness, finger identification or other data. Threshold data stores 260B may include one or more temporal thresholds, distance or spatial based thresholds, probability thresholds, or other values of comparison that gesture module 222 uses to infer classification events from user input. The thresholds stored at threshold data stores 260B may be variable thresholds (e.g., based on a function or lookup table) or fixed values.

Although described with respect to handedness (e.g., right handed, left handed) and finger identification (e.g., index finger, thumb, or other finger), the techniques may determine other data based on the heatmaps, such as the weighted area of the heatmap, the perimeter of the heatmap (after an edge-finding operation), a histogram of heatmap row/column values, the peak value of the heatmap, the location of the peak value relative to the edges, centroid-relative calculations of these feature, or derivatives of these features. Threshold data stores 260B may store this other data as well.

Presence-sensitive input component 204 may initially receive indications of capacitance, which presence-sensitive input component 204 forms into a plurality of capacitive heatmaps representative of the capacitance in the region (e.g., region 114) of presence-sensitive display 212 reflective of the user input entered at the region of the presence-sensitive display 212 over the duration of time. In some instances, communication channels 250 (which may also be referred to as a “bus 250”) may have limited throughput (or, in other words, bandwidth). In these instances, presence-sensitive input component 204 may reduce a number of the indications to obtain a reduced set of indications. For example, presence-sensitive input component 204 may determine the centroid at which the primary contact with presence sensitive display 212 occurred, and reduce the indications to those centered around the centroid (such as a 7×7 grid centered around the centroid). Presence-sensitive input component 204 may determine, based on the reduced set of indications, the plurality of multi-dimensional heatmaps, storing the plurality of multi-dimensional heatmaps to MDHM data stores 260A via bus 250.

SBD model module 226 may access the heatmaps stored to MDHM data stores 260A, applying one or more of the neural network to determine the changes, over the duration of time, in the shape of the sequence of multi-dimensional heatmaps. SBD model module 226 may next apply the one or more neural networks, responsive to the changes in the shape of the plurality of multi-dimensional heatmaps, to determine a classification of the user input.

SBD model module 226 may also determine, based on changes to the shape of the multi-dimensional heatmaps, a handedness of the user entering the user input, or which finger, of the user entering the input, was used to enter the user input. SBD model module 226 may apply the one or more of the neural networks to determine the handedness or which finger, and apply the one or more neural networks to determine the classification of the user input based on the determination of the handedness or the determination of which finger.

Gesture module 222 may also invoke TBD model module 228 to determine the classification of the user input using time-based threshold (possible in addition to the centroids of the sequence of heatmaps). As an example, TBD model module 228 may determine, based on a duration threshold, a tap event indicative of a user entering the user input performing at least one tap on the presence-sensitive screen. Gesture module 222 may then determine the classification from the combined results output by SBD model module 226 and the TBD model module 228.

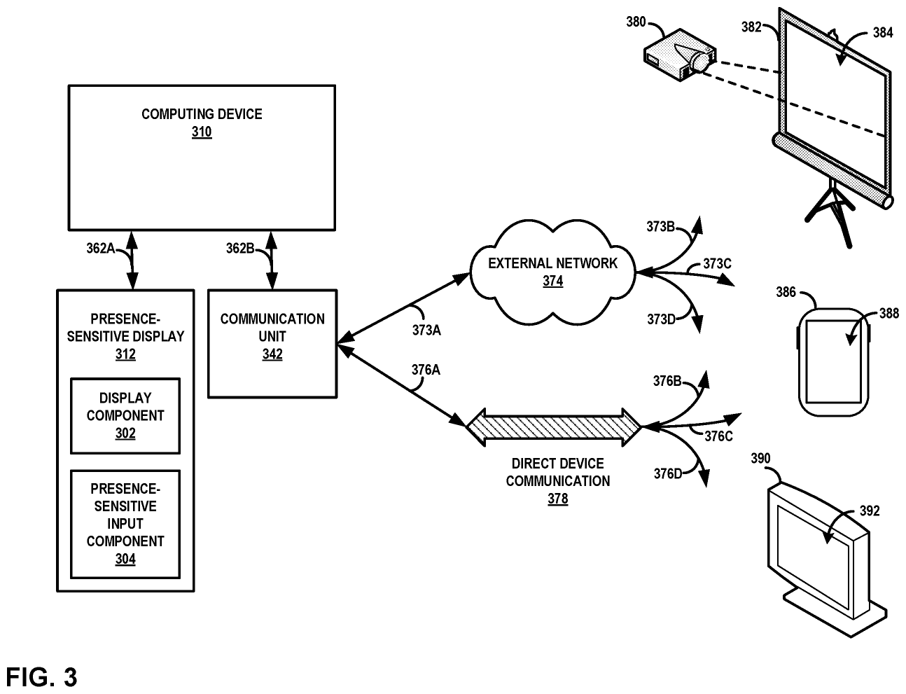

FIG. 3 is a block diagram illustrating an example computing device that outputs graphical content for display at a remote device, in accordance with one or more techniques of the present disclosure. Graphical content, generally, may include any visual information that may be output for display, such as text, images, and a group of moving images, to name only a few examples. The example shown in FIG. 3 includes a computing device 310, a PSD 312, communication unit 342, projector 380, projector screen 382, mobile device 386, and visual display component 390. In some examples, PSD 312 may be a presence-sensitive display as described in FIGS. 1-2. Although shown for purposes of example in FIGS. 1 and 2 as a stand-alone computing device 110 and 210 respectively, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing devices 110 and 210 in FIGS. 1-2 respectively, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 302 and presence-sensitive input component 304. Display component 302 may, for example, receive data from computing device 310 and display the graphical content. In some examples, presence-sensitive input component 304 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 304 may be physically positioned on top of display component 302 such that, when a user positions an input unit over a graphical element displayed by display component 302, the location at which presence-sensitive input component 304 corresponds to the location of display component 302 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates a projector 380 and projector screen 382. Other such examples of projection devices may include electronic whiteboards, holographic display components, and any other suitable devices for displaying graphical content. Projector 380 and projector screen 382 may include one or more communication units that enable the respective devices to communicate with computing device 310. In some examples, the one or more communication units may enable communication between projector 380 and projector screen 382. Projector 380 may receive data from computing device 310 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 310. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 112, 212, and/or 312 as described in this disclosure. In some examples, presence-sensitive display 384 may include additional functionality. Projector screen 382 (e.g., an electronic whiteboard), may receive data from computing device 310 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 310.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other semi-stationary devices such as televisions, computer monitors, etc. As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition processes and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such as projector 380, projector screen 382, mobile device 386, and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as projector 380, projector screen 382, mobile device 386, and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, 373C, or 373D. External network 374 may include network hubs, network switches, network routers, etc., that are operatively inter-coupled thereby providing for the exchange of information between computing device 310 and the remote devices illustrated in FIG. 3. In some examples, network links 373A-373D may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth, Near-Field Communication, Universal Serial Bus, WiFi, infrared, etc. One or more of the remote devices illustrated in FIG. 3 may be operatively coupled with computing device 310 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, computing device 310 may be operatively coupled to visual display component 390 using external network 374. Computing device 310 may output a graphical user interface for display at PSD 312. For instance, computing device 310 may send data that includes a representation of the graphical user interface to communication unit 342. Communication unit 342 may send the data that includes the representation of the graphical user interface to visual display component 390 using external network 374. Visual display component 390, in response to receiving the data using external network 374, may cause PSD 312 to output the graphical user interface. In response to receiving a user input at PSD 312 to select one or more graphical elements of the graphical user interface, visual display device 130 may send an indication of the user input to computing device 310 using external network 374. Communication unit 342 of may receive the indication of the user input, and send the indication to computing device 310.

Computing device 310 may receive the indications representative of a user input entered at a region of the presence-sensitive screen 312 over a duration of time. Computing device 310 may next determine, based on the indications representative of the user input, a plurality of multi-dimensional heatmaps indicative of the user input. Computing device 310 may then determine, based on the plurality of multi-dimensional heatmaps, changes, over the duration of time, in a shape of the plurality of multi-dimensional heatmaps, and determine, responsive to the changes in the shape of the plurality of multi-dimensional heatmaps, a classification of the user input. Computing device 310 may then perform some operation associated with the classification of the user input, which may include updating the graphical user interface. Communication unit 342 may receive the representation of the updated graphical user interface and may send the representation to visual display component 390, such that visual display component 390 may cause PSD 312 to output the updated graphical user interface.

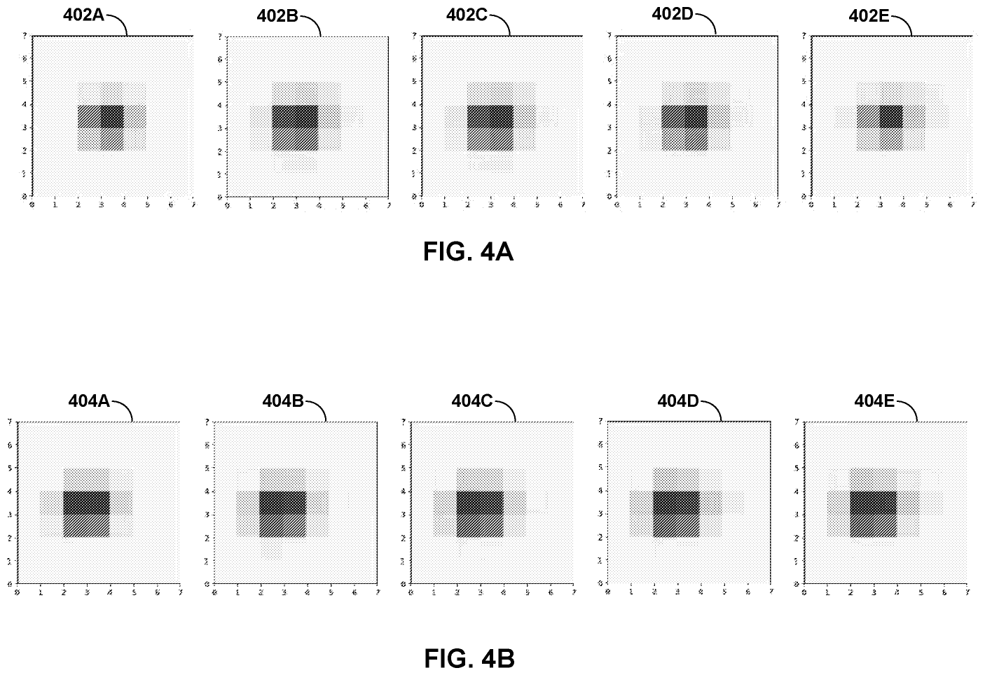

FIGS. 4A-4C are diagrams illustrating example sequences of heatmaps used by the computing device to perform disambiguation of user input in accordance with various aspects of the techniques described in this disclosure. In the example of FIGS. 4A-4C, heatmaps 402A-402E (“heatmaps 402”), heatmaps 404A-404E (“heatmaps 404”), and heatmaps 406A-406E (“heatmaps 406”) include a 7×7 grid of capacitance values, with the more darkly colored boxes indicating either a higher or lower capacitance value relative to the lighter colored boxes. Heatmaps 402 represent a sequence of heatmaps collected over the duration of time, starting with heatmap 402A and through heatmap 402E in order time-wise. As such, heatmaps 402 may represent changes in capacitance over the duration of time for the region. Heatmaps 404 and 406 are similar to heatmap 402 in these respects as well.

Referring first to FIG. 4A, heatmaps 402 were captured after the user tapped on presence sensitive display 212. Gesture module 222 (shown in the example of FIG. 2) may invoke SBD model module 226 and TBD model module 228 to determine a classification of the user input based on the changes in shape of heatmaps 402 over the duration of time. In some examples, each of the heatmaps 402 are representative of 8 ms of time. The entire sequence of heatmaps 402 may therefore represent 40 ms. Responsive to receiving heatmaps 402, SBD model module 226 may determine that a tap occurs given the consistency of shape and intensity of the capacitance values. TBD model module 228 may determine a tap event occurred as a result of the short duration of the sequence of heatmaps 402.

Referring next to FIG. 4B, heatmaps 404 were captured after the user pressed on presence sensitive display 212. Gesture module 222 may invoke SBD model module 226 and TBD model module 228 to determine a classification of the user input based on the changes in shape of heatmaps 404 over the duration of time. Again, each of the heatmaps 404 may be representative of 8 ms of time. The entire sequencer of heatmaps 404 may therefore represent 40 ms. Responsive to receiving heatmaps 404, SBD model module 226 may determine that a press event occurred given the increasing intensity over time. TBD model module 228 may determine a press event occurred as a result of the longer duration of the sequence of heatmaps 404 (which only represent a subset of a larger number of the entire sequence of heatmaps 404 for ease of illustration purposes).

Referring next to FIG. 4C, heatmaps 406 were captured after the user scrolled on presence sensitive display 212. Gesture module 222 may invoke SBD model module 226 and TBD model module 228 to determine a classification of the user input based on the changes in shape of heatmaps 406 over the duration of time. Again, each of the heatmaps 406 may be representative of 8 ms of time. The entire sequencer of heatmaps 406 may therefore represent 40 ms. Responsive to receiving heatmaps 406, SBD model module 226 may determine that a scroll event occurred given the highly variable intensity over time (and possible the changing location of the centroid). TBD model module 228 may determine a press event occurred as a result of the longer duration of the sequence of heatmaps 406 (and the changing location of the centroid).

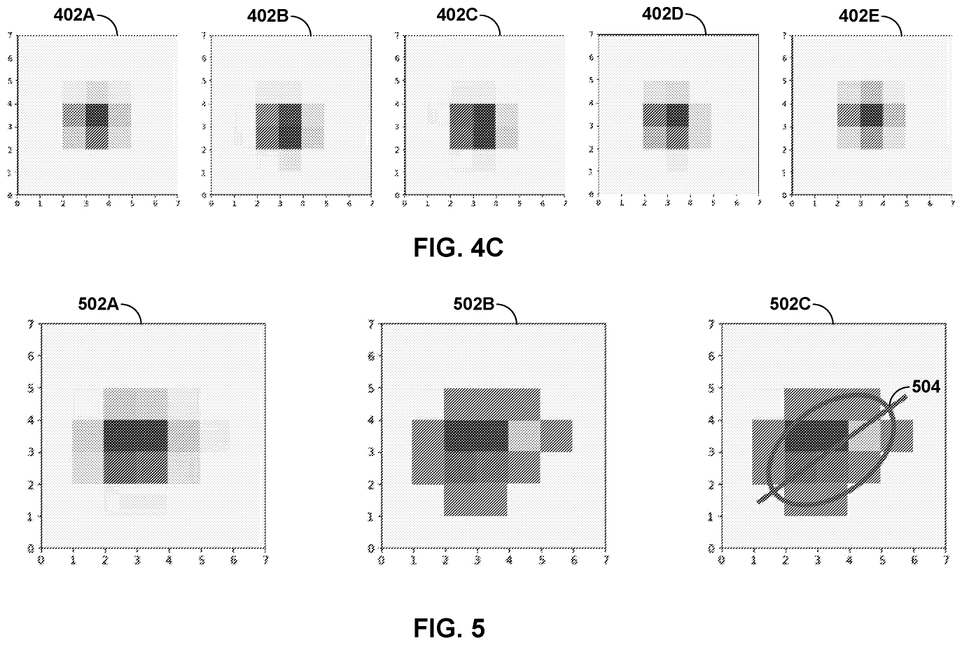

FIG. 5 is a diagram illustrating an example heatmap used by the computing device to determine a classification of a user input in accordance with various aspects of the techniques described in this disclosure. As shown in the example of FIG. 5, heatmaps 502A-502C (“heatmaps 502”) represent different classifications of the same user input entered via presence sensitive display 212 (of FIG. 2). Computing device 210 may invoke gesture module 222 responsive to receiving heatmap 502. Gesture module 222 may, in turn, invoke SBD model module 226 to determine a classification of the user input based on the shape of heatmaps 502.

As shown with respect to heatmap 502A, SBD model module 226 may, based on heatmaps 502A, determine an area of the user input. SBD model module 226 may determine the area as a sum of the values of heatmap 502A.

As shown with respect to heatmap 502B, SBD model module 226 may determine a perimeter of heatmap 502B. SBD model module 226 may first perform some form of binary thresholding (to eliminate incidental or negligible capacitance values). SBD model module 226 may next determine the perimeter of heatmap 502B as the sum of the remaining outside values of heatmap 502B.

As shown with respect to heatmap 502C, SBD model module 226 may determine an orientation of the user input. To determine the orientation, SBD model module 226 may apply a neural network to heatmap 502C, which may analyze the capacitance values to identify the orientation 504. In the example of FIG. 5, the user input has, based on heatmap 502C, an orientation of left to right with approximately a 45-degree angle above the X-axis. Based on the orientation, area and/or perimeter, SBD model module 226 may determine which finger was used to enter the user input or a handedness of the user entering the user input.

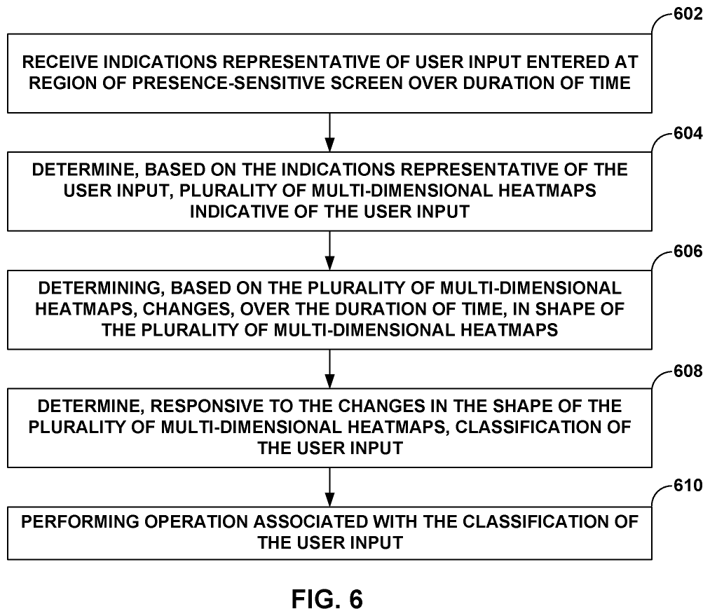

FIG. 6 is a flowchart illustrating example operations of a computing device that is configured to perform disambiguation of user input in accordance with one or more aspects of the present disclosure. FIG. 6 is described below in the context of computing device 210 of FIG. 2.

Computing device 210 may receive the indications representative of a user input entered at a region of the presence-sensitive screen 212 over a duration of time (602). Computing device 210 may next determine, based on the indications representative of the user input, a plurality of multi-dimensional heatmaps (such as heatmaps 402, 404, and/or 406 shown in the example of FIGS. 4A-4C) indicative of the user input (604). Computing device 210 may then determine, based on the plurality of multi-dimensional heatmaps, changes, over the duration of time, in a shape of the plurality of multi-dimensional heatmaps (606), and determine, responsive to the changes in the shape of the plurality of multi-dimensional heatmaps, a classification of the user input (608). Computing device 310 may then perform some operation associated with the classification of the user input, which may include updating the graphical user interface (610).

The techniques set forth in this disclosure may address issues regarding touchscreens (which is another way to refer to presence sensitive displays) that report a user's touch location based on a centroid algorithm that estimates a precise touch point (e.g., at a resolution of 1 millimeter—mm) from the contact area of the user's finger on the screen. However, much more information may be conveyed through a user's touch contact area than is captured by this centroid algorithm, which may lead to interaction errors. For example, noise and jitter in signal values at the initial stages of a finger coming into contact with the screen, and at the last stages of a finger disengaging from a screen, can cause the centroid to move sporadically and appear as rapid movements—rather than a gentle touch onset or lift. Such movements are often translated into scrolling events that cause unwanted interactions (so-called “micro-flings”).

Furthermore, the centroid algorithm may discard potentially useful information about how a user's touch contact evolves over time. The only output of the algorithm is location, which can translate over time (indicating a user dragging); but the nature of this movement—in terms of how the finger was repositioned while it was in contact with the screen—may be lost. This means that existing centroid-based implementations can only discriminate a user's touch intention with simple centroid movement and contact time information using threshold-based algorithms—potentially adding latency and imprecision.

Having additional information about the nature of a finger's contact with the screen and how it changes over time can be used to enhance existing touch interactions and eliminate errors caused by ambiguity about the user's touch intentions. Touchscreens detect interactions using a grid of electrodes that sense a human finger's presence by the change in capacitance at an electrode that is caused by the human body “leaching” capacitance away. By analyzing the capacitance value at each location on the grid, a “heatmap” can be derived in accordance with the techniques described in this disclosure.

That is, the value at each location is an analogue signal that roughly corresponds to the concentration of the contact area (i.e. the locations near the center of a finger's contact will typically have higher values than those near the periphery). The value at each location is highly dependent on the electrical properties of the user's finger and the device (e.g. touching while holding the aluminium frame of the device will produce substantially different values than touching it on a desk).

In some examples, these capacitance values bear little relationship to the force applied—that is, simply pressing harder on the screen does not change the measured capacitance. However, there is an organic change when a user presses harder on the screen: the contact area between their finger and the screen increases due to the plasticity of their skin and the increased force behind it. This expanded contact area of the finger may produce increased heatmap values at/near the new contact locations. Similar changes may be observed during the stages of a finger coming into contact or leaving the touch screen where the smooth, curved shape of the finger produces an expanding/contracting contact area—that is, when a user touches the screen normally, the tip of their finger first contacts the screen, which expands as this contact increases to a comfortable level of force. The contact area shape may also change with the user's choice of finger and posture when tapping on the screen.

The techniques described in this disclosure consider the examination of the shape of this expansion as it is represented in the heatmap, and using that shape to disambiguate the intention of the user. These intentions include whether the user is tapping on a target, trying to press on a target (i.e. with an increased level of force, but with a similar time profile as a tap), trying to initiate a scrolling action, the user's choice of finger (i.e. index finger vs. thumb), and the user's handedness (i.e. holding the device in their left or right hand).

The faster that these intentions can be identified from the onset of a touch action, the better the user experience can be—that is, reducing the dependency on time or distance centroid thresholds in order to reduce interaction latency. For example, the above interaction where a user increases the force of their touch could be detected by observing touch expansion on one side of the original contact area. This is due to the biomechanical structure of the finger, which causes pressure increases to primarily be reflected through expansion at the base of the fingertip (and not, say, above the fingernail). Therefore, if the expansion appears to be “anchored” on at least one side, and expands on the others (e.g. as a ratio of expansion from the original centroid location), the touch intention may be interpreted as an increase in touch force—that is, a “press”.

The handedness of the user may also be detected by the distortions in the orientation of the contact area observed in the heatmap that occur in particular fingers (e.g. one-handed interactions with their thumb). This additional information may then be used to adapt the centroid calculation to adjust for a bias in positioning caused by the user's posture.

Other features of interest include: the weighted area of the heatmap, the perimeter of the heatmap (after an edge-finding operation), a histogram of heatmap row/column values, the peak value of the heatmap, the location of the peak value relative to the edges, centroid-relative calculations of these feature, or derivatives of these features. The analysis of these features are potentially across the temporal dimension—that is, an intention is not identified from only a single frame, but from a signal that has evolved over some period of time.

These features could be used with heuristic algorithms (like that described above), or with machine learning algorithms that extract the essential features which correspond with various touch intentions. In some examples, the techniques do not need to examine the heatmap of the entire screen, but only the area in close proximity to the current locations of touch contact (e.g. an 7×7 grid centred on that location). Nor, in these and other examples, do the techniques necessarily replace the current threshold-based processes, but may act as accelerators for disambiguating intentions if there is sufficient confidence in the heatmap signal (retaining the existing method as a fallback).

The following numbered examples may illustrate one or more aspects of the disclosure:

### Example 1

A method comprising: receiving, by one or more processors of a computing device, indications representative of a user input entered at a region of a presence-sensitive screen over a duration of time; determining, by the one or more processors and based on the indications representative of the user input, a plurality of multi-dimensional heatmaps indicative of the user input; determining, by the one or more processors and based on the plurality of multi-dimensional heatmaps, changes, over the duration of time, in a shape of the plurality of multi-dimensional heatmaps; determining, by the one or more processors and responsive to the changes in the shape of the plurality of multi-dimensional heatmaps, a classification of the user input; and performing, by the one or more processors, an operation associated with the classification of the user input.

### Example 2

The method of example 1, wherein the indications comprise indications of capacitance in the region of the presence-sensitive screen over the duration of time, and wherein determining the plurality of multi-dimensional heatmaps comprises determining, based on the indications of capacitance, a plurality of capacitive heatmaps representative of the capacitance in the region of the presence-sensitive screen reflective of the user input entered at the region of the presence-sensitive screen over the duration of time.

### Example 3

The method of any combination of examples 1 and 2, wherein determining the plurality of multi-dimensional heatmaps includes: reducing a number of the indications to obtain a reduced set of indications; and determining, based on the reduced set of indications, the plurality of multi-dimensional heatmaps indicative of the user input.

### Example 4

The method of any combination of examples 1-3, wherein determining the classification of the user input comprises determining, responsive to the changes in the shape of the plurality of multi-dimensional heatmaps, a press event indicative of a user entering the user input applying increasing pressure, for the duration of time, to the presence-sensitive screen.

### Example 5

The method of any combination of examples 1-4, wherein determining the classification of the user input includes determining, responsive to the changes in the shape of the plurality of multi-dimensional heatmaps and based on a duration threshold, a tap event indicative of a user entering the user input performing at least one tap on the presence-sensitive screen.

### Example 6

The method of any combination of examples 1-5, further comprising determining, responsive to changes in the shape of the plurality of multi-dimensional heatmaps, a handedness of a user entering the user input, wherein determining the classification of the user input comprises determining, based on the determination of the handedness of the user entering the user input and responsive to the changes in the shape of the heatmap, the classification of the user input.

### Example 7

The method of any combination of examples 1-6, further comprising determining, responsive to changes in the shape of the plurality of multi-dimensional heatmaps, which finger, of a user entering the user input, was used to enter the user input, wherein determining the classification of the user input comprises determining, based on the determination of which finger, of the user entering the user input, was used to enter the user input and responsive to the changes in the shape of the heatmap, the classification of the user input.

### Example 8

The method of any combination of examples 1-7, wherein determining the classification of the user input comprises determining, responsive to the changes in the shape of the plurality of multi-dimensional heatmaps and based on a duration threshold, a classification of the user input.

### Example 9

The method of any combination of examples 1-8, further comprising: determining, responsive to determining the plurality of multi-dimensional heatmaps indicative of the user input, one or more centroid coordinates indicative of a relative center of one or more of the plurality of multi-dimensional heatmaps within the region of the presence-sensitive screen; and determining one or more underlying graphical elements displayed at a location within the presence-sensitive display identified by the one or more centroid coordinates, wherein performing the operation associated with the classification of the user input comprises performing, relative to the one or more underlying graphical elements, the operation associated with the classification of the user input.

### Example 10

A computing device comprising: a presence-sensitive screen configured to output indications representative of a user input entered at a region of a presence-sensitive screen over a duration of time; and one or more processors configured to: determine, based on the indications representative of the user input, a plurality of multi-dimensional heatmaps indicative of the user input; determine, based on the plurality of multi-dimensional heatmaps, changes, over the duration of time, in a shape of the plurality of multi-dimensional heatmaps; determine, responsive to the changes in the shape of the plurality of multi-dimensional heatmaps, a classification of the user input; and perform an operation associated with the classification of the user input.

### Example 11

The device of example 10, wherein the indications comprise indications of capacitance in the region of the presence-sensitive screen over the duration of time, and wherein the one or more processors are configured to determine, based on the indications of capacitance, a plurality of capacitive heatmaps representative of the capacitance in the region of the presence-sensitive screen reflective of the user input entered at the region of the presence-sensitive screen over the duration of time.

### Example 12

The device of any combination of examples 10 and 11, wherein the one or more processors are configured to: reduce a number of the indications to obtain a reduced set of indications; and determine, based on the reduced set of indications, the plurality of multi-dimensional heatmaps indicative of the user input.

### Example 13

The device of any combination of examples 10-12, wherein the one or more processors are configured to determine, responsive to the changes in the shape of the plurality of multi-dimensional heatmaps, a press event indicative of a user entering the user input applying increasing pressure, for the duration of time, to the presence-sensitive screen.

### Example 14

The device of any combination of examples 10-13, wherein the one or more processors are configured to determine, responsive to the changes in the shape of the plurality of multi-dimensional heatmaps and based on a duration threshold, a tap event indicative of a user entering the user input performing at least one tap on the presence-sensitive screen.

### Example 15

The device of any combination of examples 10-14, wherein the one or more processors are further configured to determine, responsive to changes in the shape of the plurality of multi-dimensional heatmaps, a handedness of a user entering the user input, and wherein the one or more processors are configured to determine, based on the determination of the handedness of the user entering the user input and responsive to the changes in the shape of the heatmap, the classification of the user input.

### Example 16

The device of any combination of examples 10-15, wherein the one or more processors are further configured to determine, responsive to changes in the shape of the plurality of multi-dimensional heatmaps, which finger, of a user entering the user input, was used to enter the user input, and wherein the one or more processors are configured to determine, based on the determination of which finger, of the user entering the user input, was used to enter the user input and responsive to the changes in the shape of the heatmap, the classification of the user input.

### Example 17

The device of any combination of examples 10-16, wherein the one or more processors are configured to comprises determine, responsive to the changes in the shape of the plurality of multi-dimensional heatmaps and based on a duration threshold, a classification of the user input.

### Example 18

The device of any combination of examples 10-17, wherein the one or more processors are further configured to: determine, responsive to determining the plurality of multi-dimensional heatmaps indicative of the user input, one or more centroid coordinates indicative of a relative center of one or more of the plurality of multi-dimensional heatmaps within the region of the presence-sensitive screen; and determine one or more underlying graphical elements displayed at a location within the presence-sensitive display identified by the one or more centroid coordinates, and wherein the one or more processors are configured to perform, relative to the one or more underlying graphical elements, the operation associated with the classification of the user input.

### Example 19

A system comprising means for performing any of the methods of examples 1-9.

### Example 20

A computing device comprising means for performing any of the methods of examples 1-9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
receiving, by one or more processors of a computing device, indications representative of a user input entered at a region of a presence-sensitive screen over a duration of time;
determining, by the one or more processors and based on the indications representative of the user input, a plurality of multi-dimensional heatmaps indicative of the user input;
determining, by the one or more processors and based on the plurality of multi-dimensional heatmaps, changes, over the duration of time, in a shape of the plurality of multi-dimensional heatmaps;
determining, by the one or more processors and responsive to the changes in the shape of the plurality of multi-dimensional heatmaps, a classification of the user input; and
performing, by the one or more processors, an operation associated with the classification of the user input.

2. The method of claim 1,
wherein the indications comprise indications of capacitance in the region of the presence-sensitive screen over the duration of time, and
wherein determining the plurality of multi-dimensional heatmaps comprises determining, based on the indications of capacitance, a plurality of capacitive heatmaps representative of the capacitance in the region of the presence-sensitive screen reflective of the user input entered at the region of the presence-sensitive screen over the duration of time.

3. The method of any combination of claims 1 and 2, wherein determining the plurality of multi-dimensional heatmaps includes:
reducing a number of the indications to obtain a reduced set of indications; and
determining, based on the reduced set of indications, the plurality of multi-dimensional heatmaps indicative of the user input.

4. The method of any combination of claims 1-3, wherein determining the classification of the user input comprises determining, responsive to the changes in the shape of the plurality of multi-dimensional heatmaps, a press event indicative of a user entering the user input applying increasing pressure, for the duration of time, to the presence-sensitive screen.

5. The method of any combination of claims 1-4, wherein determining the classification of the user input includes determining, responsive to the changes in the shape of the plurality of multi-dimensional heatmaps and based on a duration threshold, a tap event indicative of a user entering the user input performing at least one tap on the presence-sensitive screen.

6. The method of any combination of claims 1-5, further comprising determining, responsive to changes in the shape of the plurality of multi-dimensional heatmaps, a handedness of a user entering the user input,
wherein determining the classification of the user input comprises determining, based on the determination of the handedness of the user entering the user input and responsive to the changes in the shape of the heatmap, the classification of the user input.

7. The method of any combination of claims 1-6, further comprising determining, responsive to changes in the shape of the plurality of multi-dimensional heatmaps, which finger, of a user entering the user input, was used to enter the user input,
wherein determining the classification of the user input comprises determining, based on the determination of which finger, of the user entering the user input, was used to enter the user input and responsive to the changes in the shape of the heatmap, the classification of the user input.

8. The method of any combination of claims 1-7, wherein determining the classification of the user input comprises determining, responsive to the changes in the shape of the plurality of multi-dimensional heatmaps and based on a duration threshold, a classification of the user input.

9. The method of any combination of claims 1-8, further comprising:
determining, responsive to determining the plurality of multi-dimensional heatmaps indicative of the user input, one or more centroid coordinates indicative of a relative center of one or more of the plurality of multi-dimensional heatmaps within the region of the presence-sensitive screen; and
determining one or more underlying graphical elements displayed at a location within the presence-sensitive display identified by the one or more centroid coordinates,
wherein performing the operation associated with the classification of the user input comprises performing, relative to the one or more underlying graphical elements, the operation associated with the classification of the user input.

10. A computing device comprising:
a presence-sensitive screen configured to output indications representative of a user input entered at a region of a presence-sensitive screen over a duration of time; and
one or more processors configured to:
determine, based on the indications representative of the user input, a plurality of multi-dimensional heatmaps indicative of the user input;
determine, based on the plurality of multi-dimensional heatmaps, changes, over the duration of time, in a shape of the plurality of multi-dimensional heatmaps;
determine, responsive to the changes in the shape of the plurality of multi-dimensional heatmaps, a classification of the user input; and
perform an operation associated with the classification of the user input.

11. The device of claim 10,
wherein the indications comprise indications of capacitance in the region of the presence-sensitive screen over the duration of time, and
wherein the one or more processors are configured to determine, based on the indications of capacitance, a plurality of capacitive heatmaps representative of the capacitance in the region of the presence-sensitive screen reflective of the user input entered at the region of the presence-sensitive screen over the duration of time.

12. The device of any combination of claims 10 and 11, wherein the one or more processors are configured to:
reduce a number of the indications to obtain a reduced set of indications; and
determine, based on the reduced set of indications, the plurality of multi-dimensional heatmaps indicative of the user input.

13. The device of claim 10, wherein the one or more processors are configured to perform any combination of the steps recited by the method of claims 2-9.

14. A computer-readable medium having stored thereon instructions that, when executed, cause one or more processors to:
receive indications representative of a user input entered at a region of a presence-sensitive screen over a duration of time;
determine, based on the indications representative of the user input, a plurality of multi-dimensional heatmaps indicative of the user input;
determine, based on the plurality of multi-dimensional heatmaps, changes, over the duration of time, in a shape of the plurality of multi-dimensional heatmaps;
determine, responsive to the changes in the shape of the plurality of multi-dimensional heatmaps, a classification of the user input; and
perform an operation associated with the classification of the user input.

15. The computer-readable medium of claim 19 further having stored thereon instructions that, when executed, cause the one or more processors to perform any combination of the steps recited by the method of claims 2-9.
